(19) United States
(12) Patent Application Publication
(10) Pub. No.: US 2006/0162973 A1
(43) Pub. Date: Jul. 27, 2006

(54) Hybrid power supply module

(75) Inventors: Donald B. Harris, Arlington, VA (US); Peter Amico, Hammonton, NJ (US)

Correspondence Address: HALL, MYERS, VANDE SANDE & PEQUIGNOT, LLP, 10220 RIVER ROAD, SUITE 200, POTOMAC, MD, 20854, US

(73) Assignee: Airtrax Corporation

(21) Appl. No.: 11/289,709

(22) Filed: Nov. 30, 2005

Related U.S. Application Data
(63) Continuation of application No. 09/827,173, filed on Apr. 6, 2001, now abandoned.
(60) Provisional application No. 60/197,391, filed on Apr. 14, 2000.

(51) Int. Cl. B60L 8/00

(52) U.S. Cl. 180/65.3

(57) ABSTRACT

An hybrid power supply module is disclosed. The hybrid power supply module is configured for placement in a battery compartment of an electrically powered machine and includes a housing that contains a battery, an electrical generator or fuel cell, and control electronics. The housing is sized to fit in the host electrically-powered machine's battery compartment. The battery and electrical power generator or fuel cell are coupled electrically to the electronic controls. A method of replacing a battery.in an electric powered machine with a renewable power source is also disclosed. The method includes uncoupling the battery from the machine, removing the battery from a battery compartment of the machine, placing the hybrid power supply module in the battery compartment, and coupling the hybrid power supply module to the machine.

### CROSS-REFERENCE TO RELATED APPLICATIONS

U.S. application Ser. No. 09/056,109, filed Apr. 6, 1998. This application claims the benefit of priority from U.S. Provisional Application No. 60/197,391 filed Apr. 14, 2000, which is hereby incorporated by reference.

### STATEMENT OF GOVERNMENT INTEREST

Not applicable.

### BACKGROUND OF THE INVENTION

The present invention relates generally to power supplies and, more particularly, to a hybrid removable power supply module for a machine such as a forklift, a car, a truck or any motorized vehicle or other machines requiring a power source.

Powered machinery, and particularly mobile machinery such as motorized vehicles, fork lifts, cars, trucks and vehicles using a regenerableable source of energy are generally designed to operate on either battery (e.g. rechargeable batteries) or fossil fuel power sources (e.g. internal combustion engine, turbine engine or fuel cell). While battery and fossil fuel powered mobile machinery may have quite similar chassis, suspension, lift equipment and hydraulics, the drive portions of the machinery are generally designed specifically for either a battery or fossil fuel power supply. The nature of the drive system design makes electric and fossil fuel machinery fundamentally different and not interchangeable. For example, a forklift design optimized for battery power might include a chassis having an electric motor that powers drive wheels, and an additional electric motor that drives a hydraulic actuation system to power on board auxiliary systems such as lifting, tilting and gripping mechanisms. Whereas, a forklift design optimized for fossil fuel power might incorporate an internal combustion engine that supplies rotary mechanical power to a single hydraulic system from which pressurized fluid is metered through operator controlled valves to hydraulic cylinders and motors which actuate lifting, tilting and gripping mechanisms and also drive the wheels. This optimization of vehicle system designs around the power source makes converting motorized vehicles or machinery from one power source to another very difficult and expensive.

Each power source option has unique advantages and disadvantages. For example, battery powered systems generally have low gaseous and thermal emissions but are disadvantageously heavy, have limited operating range and require an extended period of downtime to recharge. Fossil fuel powered systems generally have high power density and less weight than battery powered systems, but disadvantageously generate gaseous, thermal, and auditory emissions. Consequently, battery powered machinery is typically used only in environmentally protected or un-vented areas, whereas fossil fuel machinery is used in well-ventilated or exterior areas. As a result, machinery users with facilities comprising both environmentally protected and exterior operating areas, such as forklift operators in warehouses with outside loading docks, must invest in both battery powered and fossil fuel powered machinery. Thus, there is a need for machinery that can be powered by either battery or fossil fuel power sources, i.e. a hybrid-power source. Furthermore, since a large installed base of self-powered machinery and vehicles exist, there is a need for an inexpensive and efficient means of converting machinery to hybrid-power capability.

A number of concepts have been disclosed for hybrid-powered vehicles, either incorporating both power sources in the vehicle or permitting the replacement of one power source with the other. Also, many designs have been disclosed for removable power sources.

U.S. Pat. No. 3,983,952 by McKee discloses an electric vehicle with a removable energy supply module. McKee's removable energy supply module is comprised of a rack of batteries, with rollers arranged under the batteries to facilitate replacement of the battery module with another similar battery module, thus enabling operating with one battery module while another is recharged.

U.S. Pat. No. 5,251,721 to Ortenheim discloses a battery and internal combustion engine (ICE) hybrid powered automobile. A removable internal combustion engine module is inserted when traveling long distances where the generation of exhaust fumes is acceptable. This vehicle is otherwise powered by an electric motor, which is permanently installed. The removable internal combustion engine power module is coupled to an input shaft when installed in the vehicle, and directly supplies rotary mechanical power to the vehicle's drive train. The internal combustion engine output is also arranged to recharge the batteries, which are carried in a removable cassette under the vehicle. The battery cassette may be removed and the vehicle operated on power from the internal combustion engine alone.

U.S. Pat. No. 4,320,814 to Middlehoven discloses a removable modular electro-hydraulic power source for mining machinery. This invention purports to provide the ability to rapidly replace the electric motor prime mover, reduction gear set, and hydraulic pumps, thus reducing vehicle down time for maintenance. The removed module is then refurbished in a facility better suited to such work than the mine. The power source for the disclosed system relies on externally provided electrical energy, supplied to the power source via an umbilical from a source remote from the mining machinery.

U.S. Pat. No. 5,419,131 Doppstadt describes a displaceably mounted power unit for use in a mobile waste processing machine. This power unit is captured to the host machine on a hinged mount arranged to provide access to the machine's interior for maintenance and repair.

Concepts for removable power supplies described above either do not permit a change over from one energy source to another, or require additional structure and mechanisms necessary for both energy sources. Removable power supplies which do not permit switching between electrochemical and fossil fuel energy sources necessarily limit the vehicle applications as discussed above. Vehicles that require structure for both electrochemical and fossil fuel energy sources will necessarily be heavier, more costly and less reliable. Also, energy module designs that require special structural and mechanical interfaces with the vehicle necessarily mean that converting a host vehicle from one type of power source to the other will require expensive, time-consuming and complex modifications. These shortcomings have added to the cost of converting vehicles to hybrid-power sources, thus contributing to the limited commercial successes of hybrid-powered vehicles and hybrid-power conversions of existing vehicles.

Thus, there is a need for a power supply module that will enable a vehicle to be selectively operated on either battery or fossil fuel power without requiring additional structure and mechanisms, or significant modifications to the design. There is a further need for a power supply module that that may be selectively operated on either battery or fossil fuel power that may replace a battery power source in machinery that was designed to be powered by battery power only. There is also a need for a device that can rapidly effect the conversion from battery power to fossil fuel power with minimum modifications of the host vehicle.

### SUMMARY OF THE INVENTION

This invention comprises a hybrid-power supply module that is designed to fit within the battery compartment of an electrically powered machine, thus permitting the machine to be converted to hybrid power simply by replacing the battery.

This invention also includes a method for converting an electrically powered machine to hybrid power by replacing the battery with a hybrid power supply module. In a preferred embodiment, the method includes uncoupling the battery from the machine, removing the battery from a battery compartment of the machine, placing the hybrid power supply module in the battery compartment, and coupling it to the machine.

The hybrid power supply module system includes a housing that contains a battery, an electrical power generator, and power supply control electronics. An operator display and interface is included separate from the housing and arranged to transmit operator commands to the hybrid power supply module and return operating information for display to the operator. The electrical power generator fuel supply may be integral with or external to the housing. The electrical power generator may take the form of an internal combustion engine-driven generator, a fuel cell, or other generator. The hybrid power supply module electrical output is connected to the host machinery or vehicle's electrical power input through the electrical connections used to connect the battery to the vehicle.

By being interchangeable with the battery in terms of form, fit, electrical interface and electrical power characteristics, this invention provides a simple and inexpensive means for converting existing battery powered mobile machinery, such as a forklift, to hybrid power with a minimum of host vehicle modification. This conversion will enable a battery powered electric forklift or other machine to operate on gaseous or liquid fossil fuels where such fuels are permissible, while retaining the ability to function on battery power alone in areas where acoustic, thermal, and gaseous emissions are not desired.

By being interchangeable with a conventional battery, this invention permits the vehicle to be converted back to all battery power when fossil fuel capabilities are not useful, thus providing the ability to inexpensively increase the machine endurance.

Another objective of this invention is to provide a means by which a machine such as a forklift can be rapidly reconfigured between conventional battery only and combined battery and fuel cell or internal combustion engine power.

Yet another objective of this patent is to provide a hybrid power supply module consisting of a fossil fueled internal combustion engine powered generator or a fuel cell generator capable of supplying the average energy needs of an industrial machine, such as a fork lift, mated with a battery which, together with the generator, are capable of satisfying peak power requirements, along with the systems to modulate and control state and rate of charge, peak currents, and over running load power regeneration, all packaged in a volume and weight equal to or less than that of the battery that it replaces.

Another objective of this invention is to provide an energy module that can enable on-the-fly change over of power supply so that a fork lift or other mobile machine can operate without pollution in a factory wherein workers are employed and revert back to a warehouse using internal combustion provided power without stopping to make physical changes to the vehicle.

Accordingly, the present invention provides solutions to the shortcomings of prior power sources. Those of ordinary skill in the art will readily appreciate, however, that those and other details, features and advantages will become further apparent as the following detailed description of the preferred embodiments proceeds.

### BRIEF DESCRIPTION OF THE DRAWINGS

FIG. 1. is a cut away perspective view of the first preferred embodiment of the invention showing components and their general arrangement;

FIG. 2 is a schematic of the first preferred embodiment of the invention showing the interrelationship and connectivity of major components;

FIG. 3. is a cut away perspective view of the second preferred embodiment of the invention showing components and their general arrangement;

FIG. 4. is a schematic of the second preferred embodiment of the invention showing the interrelationship and connectivity of major components;

FIG. 5. is a perspective view of the invention being vertically installed into a conventional forklift.

### DETAILED DESCRIPTION OF THE INVENTION

The drawings presented are for the purpose of illustrating present embodiments of the invention only and not for the purpose of limiting the same.

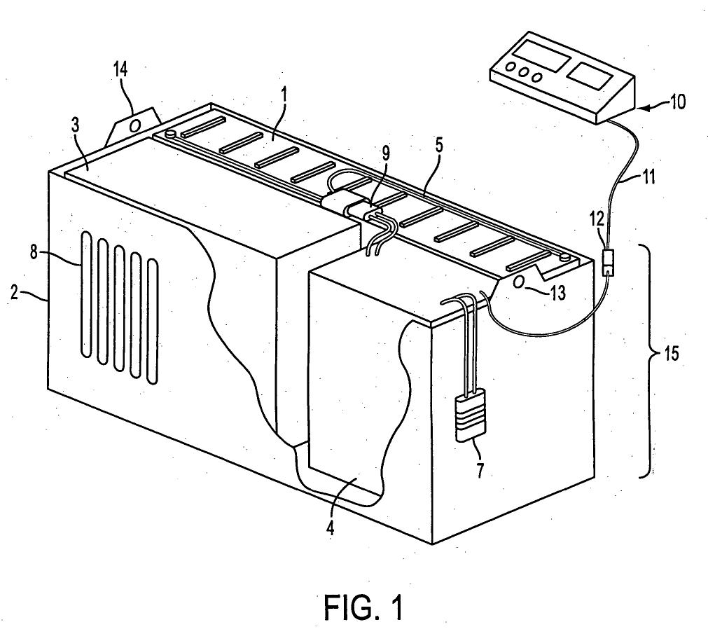

The first preferred embodiment of the invention is presented as FIG. 1 and includes the hybrid power supply module 15. The hybrid power supply module 15 includes a housing 2. Portions of the exterior surfaces of the housing 2 have been cut away in FIG. 1 to reveal interior details and exemplary arrangements of various components. Enclosed within the housing 2 are a battery 1, a fuel cell electrical power generator 3, and control electronics 4. The fuel cell electrical power generator 3 and control electronics 4 are electrically connected via cabling not shown. The battery 1 and control electronics 4 are electrically connected via cabling 5, which may include a plug disconnect 9 in series. The hybrid power supply module 15 is electrically connected to the host vehicle's power input via electrical cabling and a plug disconnect 7. An operator display and interface 10 is electrically linked to the control electronics 4, through an umbilical 11 and plug disconnect 12, or via a wireless connection (not shown). The battery 1 may be alead acid type commonly used in mobile machinery or other any other type. The battery 1 size, and voltage are determined by the electrical power requirements of the host vehicle. The fuel cell electrical power generator may be of the type disclosed by Kaufman and Werth in U.S. Pat. Nos. 5,292,600 and 5,629,102, or they may be any other type which produces electrical power. The control electronics 4 conditions and modulates the flow of electrical energy to the battery 1 and driven machine.

The hybrid power supply module 15 housing 2 may be fabricated from, for example, metal, plastic, or another suitable material and may be sized to fit into the battery compartment of an electric powered mobile machine such as a fork lift or other mobile equipment. The housing 2 of FIG. 1, may also have a smooth exterior surface and lack protrusions from the exterior surface to simplify installation into and removal from battery compartment. The housing 2 is equipped with first lift point 13 and second lift point 14 to facilitate handling by overhead hoist machinery. Ports for exterior air intake and exhaust discharge 8 may be provided and are depicted on the side of the module in FIG. 1. The air intake and exhaust discharge ports 8 may alternately be located on any side, top, or bottom of the housing 2.

The fuel cell fuel storage container is depicted as being integral with the fuel cell 3 and thus may be incorporated into the housing 2 as shown in FIG. 1, to form a single, self-contained hybrid power supply module 15 that can be lifted, transported, stored, installed, operated, and removed from the host machine as a single unit. In another embodiment, the fuel storage tank not shown is carried by the host vehicle external to the hybrid power supply module 15. The fuel supply tank, not shown, will have a pipe connection, not shown, to convey fuel to the fuel cell 3, and may have a fill connection, not shown, to replenish fuel, and a means to sense and transmit fuel level to the control electronics 4, not shown.

The fuel cell 3 may be a common type that oxidizes hydrogen or other fuel and produces an electrical current. The fuel cell 3 will be electrically connected to the control electronics 4. The control electronics 4 will monitor all facets of the hybrid power supply module 15 including the fuel cell's 3 temperature and other operating parameters, fuel supply level, electrical currents, and battery 1 voltage.

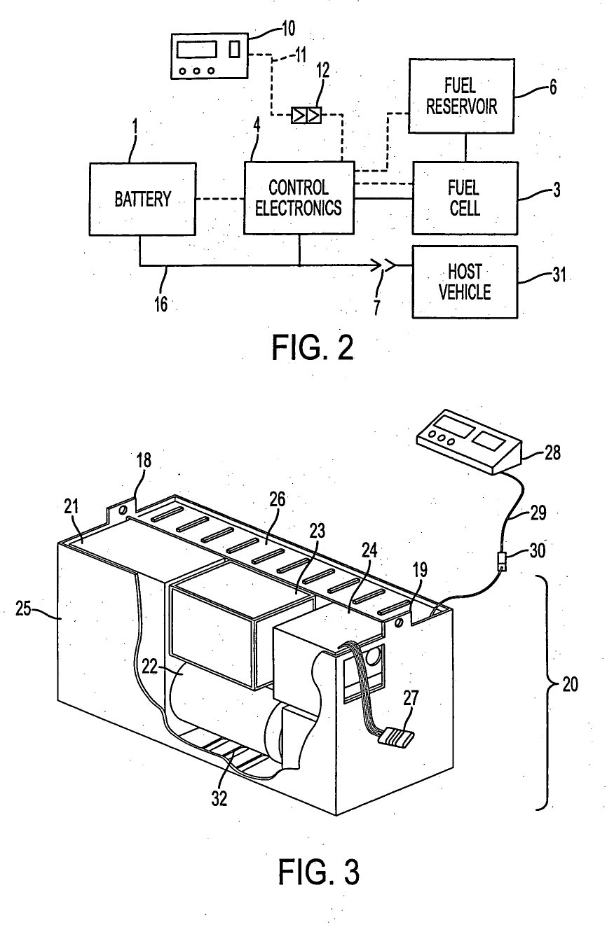

The first preferred embodiment of the invention is presented schematically in FIG. 2. Referring now to FIG. 2, as shown in the schematic, solid lines depict the flow of power whereas dashed lines depict the flow of information. The battery 1, electronic controls 4, and host vehicle 31 power input 7 are electrically connected in parallel on a single buss 16. The control electronics 4 will condition the electrical energy from the fuel cell generator 3 and supply current to the buss 16. The electronic controls 4 are arranged to continuously and automatically modulate the electrical current to the buss 16 in consonance with its measured electrical potential to accommodate a rapidly varying demand.

The buss 16 potential corresponds very closely with the battery 1 potential. Those practiced in the art know that a lead acid battery's 1 state of charge can be determined by, among other means, its electrical potential. A high electrical potential indicates a higher charge and conversely, a low electrical potential indicates a lower charge.

The fork lift truck or other host vehicle 31 will have varying power demands. Power demanded by the host vehicle 31 will draw electrical current from the buss 16. In the absence of a fuel cell, the battery 1 electrical potential, and therefore buss 16 potential, will drop with increasing host vehicle 31 current demand.

For example, in an embodiment of the invention that may be used to power a commercial forklift, the hybrid power supply module 20 could consist of a 2.5 KW or so fuel cell 3 and a 48 volt potential, 8 kilowatt-hour, or so, capacity lead acid battery 1, and electronic controls 4 all contained within a steel housing 2. The battery 1 capacity can also be expressed in ampere-hours. In this case, a 48 volt, 8 kilowatt-hour battery will have a capacity of about 167 ampere-hours. This capacity is generally the value which the battery can supply at a constant rate over a six hour time period and is thus referred to as the “six hour rate” by those practiced in the art. As stated before, the battery 1, electronic controls 4, and host vehicle power input 7 are electrically connected in parallel on a single buss 16.

The battery 1 potential is generally equal to the product of the number of cells and the cell potential. A lead acid battery will have a nominal open circuit potential of slightly over 2.0 volts per cell when fully charged. The 48 volt battery 1 used in this illustrative example has 48/2 or 24 cells. The battery 1 potential drops as energy is removed, and is generally considered discharged by those practiced in the art when the per cell open circuit potential reaches 1.75 volts or, when multiplied by twenty four cells, 42.0 volts for this illustrative example.

In addition, the battery 1 voltage will drop when supplying current to a connected electrical load. The reduction in voltage will be greater with increasing current drawn from the battery 1 and may reach a value of 0.2 volts per cell or more. For the illustrative example, this translates to 48 v-[0.2 v/cell][24 cells] or 43.2 volts for a fully charged battery 26 or 42 v-[0.2 v/cell][24 cells] or 37.2 volts when fully discharged.

A lead acid battery is recharged by reversing the flow of electric current. Electricity flows from-higher potential to a lower one, so for electrical current to flow into the battery its potential must exceed that of the battery 1. Charging potentials for lead acid batteries are typically about 0.3 volts per cell, or so, above the battery's 1 open circuit potential which will result in an electrical current roughly equivalent to 15 percent of the “six hour rate” ampere-hour rating. Greater potentials and currents are not desirable, since these may damage the battery 1. Furthermore, as the battery 1 is charged the current must be reduced so the battery 1 does not overheat.

When the battery 1 is at a low charge, or current draws by the host vehicle 31 is high, as indicated by a low electrical buss 16 potential, the fuel cell 3 and electronic controls 4 will supply a higher current to the buss 16. When there is little current drawn by the host vehicle 31 and the battery 1 is nearly fully charged, as indicated by a high electrical buss 16 potential, the fuel cell 3 and electronic controls 4 will supply a smaller current to the buss 16. The fuel cell 3 and electronic controls 4 will reduce the current to the battery 1 to a very small value when it reaches a value which corresponds to a fully charged battery 1. In one preferred embodiment of the invention, the fuel cell 3 and electronic controls 4 are arranged to provide maximum current at buss potentials below about 1.75 volts per cell, current in amperes of approximately 15 percent of the battery 1 “six hour rate” ampere-hour rating at buss 16 potentials from 1.75 to 2.1 volts per cell, current of about 4 percent of the battery 1 “six hour rate” ampere-hour rating at buss 16 potentials from 2.1 to 2.7 volts per cell, and current not exceeding 0.5 percent of the battery 1 six hour ampere-hour rating at buss 16 potentials above 2.7 volts per cell. When static or operating at low loads, the electrical current supplied to the buss 16 from the fuel cell 3 via electronic controls 4 serves to maintain the battery 1 in a state of high charge and to prevent damage from overcharging. This translates to the following for the aforementioned illustrative example:

| | Current Supplied to Buss by |
|---|---|
| | Generator and Electronic Controls, |
| Buss Potential, Volts | Amperes |
| Below 42 | 70 |
| 42 to 50.4 | 25 |
| 50.4 to 64.8 | 7 |
| Above 64.9 | 1 |

The fuel cell 3 may not be capable of supplying the transient peak energy demands of the forklift 31 or other host vehicle. This will manifest itself when more electrical current is drawn from the buss 16 than can be supplied by the fuel cell 3 via the electronic controls 4. In this instance, the excess power required is supplied by the battery 1. This occurs when the host vehicle's 31 electrical current demand exceeds the maximum value of electrical current available from the fuel cell 3 and electronic controls 4. In the case of this illustrative example, the current from the fuel cell 3 via the control electronics 4 which normally charges the battery 1 reverses to make up the difference. This reversal occurs automatically and passively. After the transient event has passed, and the host vehicle 31 electrical current demand drops to a value below that which is supplied by the fuel cell 3 and electronic controls 4, the surplus current will once again be returned to the battery 1 for charging.

Also in the embodiment illustrated in FIG. 2, an operator display and interface 10 is linked to the electronic controls 4, for example, by wiring through an umbilical 11 and plug 12, or via a wireless connection (not shown). In the embodiment in which the operator display and interface 10 is wired to the electronic controls 4, the operator display and interface 10. will receive electrical power from the battery 1 and/or fuel cell 3 via the electronic controls 4. In the embodiment in which the operator display and interface 10 uses a wireless connection not shown between the electronic controls 4 and operator display and interface 10, electrical power to operate the display 10 may be supplied by a commercially available disposable or rechargeable battery (not shown) mounted within the operator display and interface 10. In operation, the operator display and interface 10 continuously informs the human operator of the state of battery 1 charge, fuel cell 3 status, and other sensed parameters, and advises when the fuel cell 3 should be operated. The operator display and interface 10 may incorporate a screen, gauges, light emitting diodes or other apparatuses (not shown) for conveying the measured parameters. In one embodiment, a switch (not shown) is provided on the operator display and interface 10 for the operator to select manual or automatic fuel cell 3 operation. Push buttons (not shown) are provided on the operator display and interface 10 for starting and securing the fuel cell 3 when in the manual mode.

The hybrid power supply module 15 may have two modes of operation: manual and automatic. In the manual mode, the authority to operate the fuel cell 3 resides with the operator. The operator may, for example, start the fuel cell 3 to replenish the battery 1 charge by depressing the start button (not shown) on the operator display and interface 10. The fuel cell 3 will then start and supply electrical current to the buss 16 via controls 4 without further action by the operator. Depressing the stop button (not shown) will secure the fuel cell 3. The electronic controls 4 may also function to shut-off the fuel cell 3 automatically if the battery 1 becomes 100% charged to prevent damage to the battery 1 from overcharging. The manual mode is generally selected to prevent operation of the fuel cell 3 when operating in areas where waste heat, moisture, and fumes are problematic. The automatic mode is generally used when functioning in areas where the waste heat, moisture, and fumes from the fuel cell 3 are acceptable. In all cases, the electronic controls 4 will inform the operator of the state of charge of the battery 1 and advise when the fuel cell 3 should be operated to replenish the battery 1 when discharged. In the automatic mode, the electronic controls 4 will automatically start, operate, and secure the fuel cell 3 in accordance with predetermined values of sensed parameters including battery charge level and host vehicle energy consumption rate.

Whether in manual or automatic mode, the function of the fuel cell 3 is overseen by the electronic controls 4 which starts, operates, monitors, and secures the fuel cell 3 without firther action by the operator. The electronic controls 4 monitor the fuel cell 3 performance parameters such as temperature, fuel level, and electrical status, and convey visual and audible alerts, cautions, and warnings to the operator via the operator interface and display 10 when values outside a prescribed range are sensed. The fuel cell 3 may be arranged to automatically reduce output or secure if a critical sensed parameter such as temperature reaches a predetermined threshold. In that event, the operator will also be notified via visual and audible alerts of the termination along with the condition that caused the shut-down.

The second preferred embodiment of the invention is presented in FIG. 3 and includes the hybrid power supply module 20. The hybrid power supply module 20 includes an housing 25. Portions of the exterior surfaces of the housing 25 have been cut away in FIG. 3 to reveal interior details and exemplary arrangements of various components. Enclosed within the housing 25 are a battery 26, an internal combustion engine 21 drivingly connected to an generator 22, a fuel storage tank 23, and control electronics 24. The electrical power generator 22 and control electronics 24 are electrically connected via cabling, not shown. The battery 26 and control electronics 24 are also electrically connected via cabling, not shown. The hybrid power supply module 20 depicted in FIG. 3 is electrically connected to the host vehicle's power input via electrical cabling and a plug disconnect 27. An operator display and interface 28 is electrically linked to the control electronics 24, through an umbilical 29 and plug disconnect 30, or via a wireless connection, not shown.

The hybrid power supply module housing 25 may be fabricated from, for example, metal, plastic, or another suitable material and may be sized to fit into the battery compartment of an electric powered mobile machine such as a fork lift or other mobile piece of equipment. By way of example, a hybrid power supply module housing suitable for industrial machinery may have external dimensions on the order of 15 to 24 inches in width, 30 to 50 inches in length, and 18 to 30 inches in height. In a preferred embodiment, of a hybrid power supply module housing for a fork lift, the housing external width, length, and height are approximately 21, 38, and 24 inches respectively. The housing 25 of FIG. 3, may also have a smooth exterior surface and lack protrusions from the exterior surface to simplify installation and removal into said battery compartment. The housing is equipped with a first lift points 18 and a second lift point 19 to facilitate handling by overhead hoist machinery not shown. Ports for exterior air intake and exhaust discharge 32 are depicted on the bottom of the hybrid power supply module 20 in FIG. 3. The exterior air intake and exhaust discharge ports 32 may alternately be located on any side or top of the housing 25.

The internal combustion engine 21 may consume fossil fuel such as, for example, gasoline, diesel, propane gas, natural gas, or other fuel such as alcohol and may be of reciprocating (i.e., piston driven) or rotary engine design. The internal combustion engine 21 may also be a spark ignition type engine, such as a gasoline reciprocating or rotary engine that uses spark plugs to ignite the fuel, or a compression ignition type engine, such as a diesel engine. For example, a suitable internal combustion engine would Fischer Panda PMS 04 D, which produces 4 Kilowatts of electrical power using diesel fuel and is contained within an envelope of 21 inch high, 21 inches long, and 15 inches wide including starting, cooling, muffling, and engine control systems. The internal combustion engine 21 will be fitted with ancillary starting, intake air filtration, cooling, lubricating, muffling, and speed governing systems well known to those practiced in the art and not shown in any FIG. All such ancillary equipment and systems are contained within the housing 25. The internal combustion engine 21 will be fitted with sensors not shown which provide an electrical signal which can be correlated to the engine 21 temperature and lubricating oil pressure. These sensed parameters will be transmitted to the electrical controls 24 via electrical cabling not shown.

The fuel storage tank 23 may be incorporated into the housing 25 as depicted in FIG. 3, to form a single, self-contained hybrid power supply module 20 that can be lifted, transported, stored, installed, operated, and removed from the host machine as a single unit. In another embodiment, the fuel storage tank 23 is carried by the host vehicle external to the hybrid power supply module 20. The fuel supply tank will have a pipe connection not shown to convey fuel to the internal combustion engine 21, a fill connection not shown to replenish fuel, and a means to sense and transmit fuel level to the control electronics 24, also not shown.

The generator 22 may be a common type that converts mechanical energy, in the form of, for example, a rotating shaft of the internal combustion engine 21, to electrical energy. The generator 22 will be electrically connected to the control electronics 24. The control electronics will monitor all facets of the hybrid power supply module 20 including the internal combustion engine's 21 speed, temperature, and lubricating oil pressure, fuel tank 23 level, electrical currents, and battery 26 voltage/state of charge.

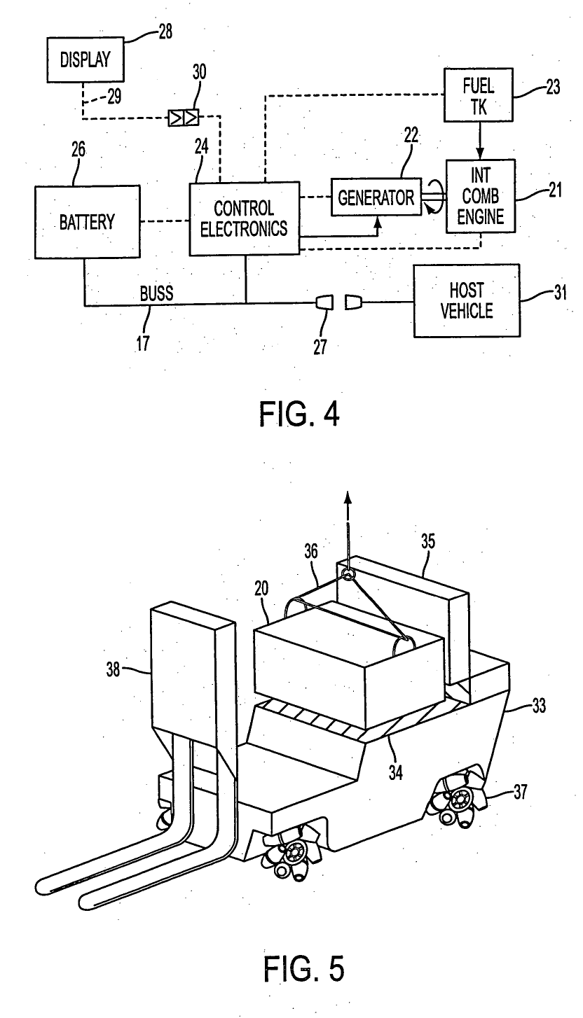

The second preferred embodiment of the invention is presented schematically in FIG. 4. As shown in the schematic, solid lines depict the flow of power whereas dashed lines depict the flow of information such as commands and sensed parameter feedback. Referring now to FIG. 4, the battery 26, electronic controls 24, and host vehicle 31 power input 27 are electrically connected in parallel on a single buss 17. The control electronics 24 will rectify and condition the electrical energy from the generator 22 and supply current to the buss 17. The electronic controls 24 are arranged to continuously and automatically modulate the electrical current to the buss 17 in consonance with its measured electrical potential to automatically accommodate a rapidly varying power demand.

The buss 17 potential corresponds very closely with the battery 26 potential. Those practiced in the art know that a lead acid battery's 26 state of charge can be determined by, among other means, its electrical potential. A high electrical potential indicates a higher charge and conversely, a low electrical potential indicates a lower charge.

The fork lift truck or other host vehicle 31 will have varying energy demands. Demand from the host vehicle 31 will draw electrical current from the buss 17. In the absence of a generator, the battery 26 electrical potential, and therefore buss 17 potential, will drop with increasing host vehicle 31 current demand.

For example, in an embodiment of the invention that may be used to power a commercial forklift, the hybrid power supply module 20 could consist of a 5 horse power internal combustion engine 21 coupled to a 2.5 KW electrical generator 22 and a 48 volt potential, 8 kilowatt-hour capacity lead acid battery 26, and electronic controls 24 within a steel housing 25. The engine may be coupled to the generator by a direct or flexible shaft, gear box, toothed belt, v-belt or other suitable mechanism for transferring rotary power. The battery 26 capacity can also be expressed in ampere-hours of energy. Generally, this rating is at a rate which would deplete eighty percent of the battery energy over a six hour period. In this case, a 48 volt, 8 kilowatt-hour battery will have a capacity of about 167 ampere-hours. This battery is then similar to that used in the first preferred embodiment of the invention described above and as such will have an open circuit potential of 48 volts when fully charged and approximately 42 volts when eighty percent discharged. The battery potential when supplying electrical energy will similarly be reduced to a value of approximately 43.2 volts when fully charged and 37.2 volts when eighty percent discharged as described in the first preferred embodiment. The characteristics of the electrical potential required to recharge the battery 26 will also be similar to that described for the first embodiment of the invention.

When the battery 26 is at a low charge, or current drawn by the host vehicle 31 is high, as indicated by a low electrical buss 17 potential, the generator 22 and electronic controls 24 will supply a higher current to the buss 17. When there is little current drawn by the host vehicle 31 and the battery 26 is nearly fully charged, as indicated by a high electrical buss 17 potential, the generator 22 and electronic controls 24 will supply a smaller current to the buss 17. The generator 22 and electronic controls 24 will reduce the current to the battery 26 to a very small value when it reaches a value which corresponds to a fully charged battery 26. In one preferred embodiment of the invention, the generator 22 and electronic controls 24 are arranged to provide maximum current at buss potentials below about 1.75 volts per cell, current in amperes of approximately 15 percent of the battery 26 six hour ampere-hour rating at buss 17 potentials from 1.75 to 2.1 volts per cell, current of about 4 percent of the battery 26 six hour ampere-hour rating at buss 17 potentials from 2.1 to 2.7 volts per cell, and current not exceeding 0.5 percent of the battery 26 six hour ampere-hour rating at buss 17 potentials above 2.7 volts per cell. When static or operating at low loads, the electrical current supplied to the buss 17 from the generator 22 and electronic controls 24 serves to maintain the battery 26 in a state of high charge and to prevent damage from overcharging. This translates to the following for the illustrative example:

| | Current Supplied to Buss by |
|---|---|
| | Generator and Electronic Controls, |
| Buss Potential, Volts | Amperes |
| Below 42 | 70 |
| 42 to 50.4 | 25 |
| 50.4 to 64.8 | 7 |
| Above 64.9 | 1 |

The electrical power generator 22 may not be capable of supplying the transient peak energy demands of the forklift 31 or other host vehicle. This will manifest itself when more electrical current is drawn from the buss 17 than can be supplied by the generator 22 via the electronic controls 24. In this instance, the excess power required is supplied by the battery 26. This occurs when the host vehicle's 31 electrical current demand exceeds the maximum value of electrical current available from the generator 22 and electronic controls 24. In this case, the current from the generator 22 via the control electronics 24 which normally charges the battery 26 reverses to make up the difference. This reversal occurs automatically and passively. After the transient event has passed, and the host vehicle 31 electrical current demand drops to a value below that supplied by the generator 22 and electronic controls 24, the surplus current will once again be returned to the battery 26 for charging.

Also in the second preferred embodiment illustrated in FIG. 4, an operator display and interface is linked to the electronic controls 24, for example, by wiring through an umbilical 29 and plug 30, or via a wireless connection not shown. In the embodiment in which the operator display and interface 28 is wired to the electronic controls 24, the operator display and interface 28 will receive electrical power from the battery 26 via the electronic controls 24. In the embodiment in which the operator display and interface 28 uses a wireless connection between the electronic controls 24 and operator display and interface 28, electrical power to operate the display 28 may be supplied by a commercially available disposable or rechargeable battery not shown mounted within the operator display and interface 28. In operation, the operator display and interface 28 continuously informs the human operator of the state of battery charge, electrical generator fuel tank level, and other sensed parameters, and advises when the generator 22 should be operated. The operator display and interface 28 may incorporate a screen, gauges, light emitting diodes or other apparatuses not shown for conveying the measured parameters. In one embodiment, a switch not shown is provided at the operator display and interface 28 for the operator to select manual or automatic generator 22 operation. Push buttons not shown are provided for starting and stopping the generator 22 when in the manual mode.

The hybrid power supply module 20 may have two modes of operation: manual and automatic. In the manual mode, the authority to operate the generator 22 resides with the operator. The operator may, for example, start the generator 22 to replenish the battery 26 charge by depressing the start button on the operator display and interface 28. The power generator 22 will then start and supply electrical current to the buss 17 without further action by the operator. Depressing the stop button not shown will shut-off the generator 22. The electronic controls 24 may also function to shut-off the power generator 22 automatically if the battery 26 becomes 100% charged to prevent damage to the battery 26 from overcharging. In the automatic mode, the electronic controls 24 will automatically start and shut-off the generator 22 in accordance with predetermined values of sensed parameters including battery charge level and rate of energy consumption.

The manual mode is generally selected to prevent operation of the power internal combustion engine 21 when finctioning in areas where noise, heat, and fumes are problematic. The automatic mode is generally used when functioning in areas where the noise, heat, and fumes from the internal combustion engine 21 are acceptable. In all cases, the operator display and interface 28 will inform the operator of the state of charge of the battery 26 and advise when the generator 22 should be operated.

Whether under manual or automatic control, the function of the generator is overseen by the electronic controls 24 which starts, operates, and monitors, and secures the generator without action by the operator beyond pressing the appropriate button.

The electronic controls 24 monitor the internal combustion engine 22 performance parameters such as temperature, oil pressure, fuel level, and electrical status, and conveys visual and audible warnings to the operator via the operator interface and display 28 when values outside a prescribed range are sensed. The internal combustion engine 21 and electrical generator 22 are shut down and secured automatically if a critical sensed parameter such as oil pressure or temperature reaches a predetermined threshold. In that event, the operator will also be notified via visual and audible alerts of the termination along with the condition that caused the shut-down.

Referring now to FIG. 5, the hybrid power supply module 20 is shown being lowered into an electric fork lift 33 battery compartment 34 wherein an access cover 35 of the forklift 33 is opened to receive the hybrid power supply module 20. While the second preferred embodiment of the hybrid power supply module 20 has been used to illustrate the act of installing it in the place of the regular electric fork lift 33 battery not shown. The installation of the first embodiment of the hybrid power supply module will be similar. The hybrid power supply module 20 may be placed in the forklift 33 by some means of an overhead lifting device not shown. It is also shown that the invention may be equipped with lifting fixtures 36 and associated hardware to facilitate handling by an overhead lifting device not shown. The forklift 33 illustrated includes an electrically powered drive train consisting of omni directional wheels 37 that are rotatably attached to the fork lift 33 chassis. A lifting mechanism 38 is also operably affixed to the fork lift 33 which may, for example, include lifting, tilting and gripping mechanisms to facilitate material handling by the fork lift 33. As evidenced by the foregoing description, one aspect of this invention is the design of a removable hybrid power supply module 20 for machinery such as, but not limited to, a forklift 33.

In another embodiment, an external combustion engine may be coupled to an electric generator and enclosed within a housing with an electrical storage device such as a battery. In such an embodiment, an external heat transfer device, such as a boiler or burner, adds energy to the working fluid, such as water or air, which is then expanded within the engine to drive a piston or turbine, which turns a drive shaft. The drive shaft of the external combustion engine is coupled, such as through a gear box, a toothed belt or a v-belt, to an electric generator which produces electricity used to operate the vehicle and to charge the battery. A suitable external combustion engine would be a gas turbine.

In yet another. embodiment, an external source of high pressure gas, such as compressed air, is used as the working fluid that drives a piston or turbine engine which is coupled to an electrical storage device. In such an embodiment, compressed gas is fed from an external compressor or gas storage tank to the engine via a high pressure hose. The high pressure gas is expanded within the engine to drive a piston or turbine, which turns a drive shaft. The drive shaft of the compressed-gas engine is coupled to an electric generator which produces electricity used to operate the vehicle and to charge the battery. Such an embodiment would be useful in applications where environmental considerations preclude using a combustion engine, operational requirements exceed the stored energy capacity of batteries and it is possible to connect the vehicle to a high pressure air supply via an air hose.

While various embodiments of the present invention have been described above and in the drawings, it should be understood that they have been presented only as examples, and not as limitations. Thus, the breadth and scope of the present invention should not be limited by any of the above-described exemplary embodiments, but should be defined only in accordance with the following claims and their equivalents.

What is claimed is:

1. A removable power source, comprising:
a housing;
a battery disposed within said housing;
an electrical power generator disposed within said housing; and
a power control module disposed within said housing and coupled to said battery and said electrical power generator and arranged to supply power to a machine from either said battery or said generator.

2. The power source of claim 1, wherein said electrical power generator further comprises:
an internal combustion engine; and
an electrical generator coupled to said internal combustion engine.

3. The power source of claim 1, wherein said electrical power generator further comprises a fuel cell.

4. The power source of claim 1, wherein said housing is sized to fit in a compartment for holding a battery of said machine.

5. The power source of claim 4, wherein said housing is removable from the compartment for holding a battery.

6. The power source of claim 2, wherein said internal combustion engine is a spark ignition engine.

7. The power source of claim 2, wherein said internal combustion engine is a compression ignition engine.

8. The power source of claim 2, wherein said internal combustion engine is a rotary engine.

9. The power source of claim 2, wherein said internal combustion engine is a reciprocating engine.

10. A method of replacing a battery in an electric powered machine with a rapidly renewable power source, comprising:
uncoupling the battery from the machine;
removing the battery from the battery compartment of the machine;
placing a rapidly renewable power source in the battery compartment; and
coupling the rapidly renewable power source to the machine.

11. A method for converting a battery-powered machine to a hybrid powered machine comprising the steps:
uncoupling the battery from the machine;
removing the battery from the machine;
placing a hybrid power source in the battery compartment of the machine; and
coupling the hybrid power source to the machine.

12. A vehicle, comprising:
a chassis;
a wheel rotatably attached to said chassis;
an electric motor coupled to said chassis and to said wheel; and
a power source electrically coupled to said electric motor, said power source comprising;
a housing,
a battery disposed within said housing,
a power control module disposed within said housing and coupled to said battery, and
an electrical power generator disposed within said housing and coupled to said power control module.

13. The vehicle disclosed in claim 12 wherein said vehicle is a forklift further comprising
a lifting mechanism coupled to said chassis.

14. The vehicle disclosed in claim 12 wherein said vehicle is a work platform further comprising a scissor type lifting mechanism coupled to said chassis.

15. The vehicle of claim 12, wherein said housing is removable as a unit.

16. The power source of claim 1, wherein said electrical power generator further comprises:
an external combustion engine; and
an electrical generator coupled to said external combustion engine.

17. The power source of claim 16, wherein said external combustion engine is a gas turbine.
